(19) United States
(12) Patent Application Publication
(10) Pub. No.: US 2026/0133066 A1
(43) Pub. Date: May 14, 2026

(54) CONFIGURING WAVEGUIDING STRUCTURES FOR DETECTING OPTICAL WAVES

(71) Applicant: Ciena Corporation, Hanover, MD (US)

(72) Inventors: Charles Baudot, Quebec (CA); Elnaz Afsharipour, Quebec (CA); Marie-Josee Picard, L'Ancienne-Lorette (CA)

(21) Appl. No.: 19/380,214

(22) Filed: Nov. 5, 2025

Related U.S. Application Data
(60) Provisional application No. 63/720,418, filed on Nov. 14, 2024.

(51) Int. Cl. G01J 1/04

(52) U.S. Cl. CPC G01J 1/0422

(57) ABSTRACT

An apparatus for detecting optical waves comprises one or more closed-loop waveguiding structures (CWSs) formed from a core material, each CWS configured to guide optical waves along a closed-loop path. A coupling waveguiding structure is formed from the core material comprising: a first optical coupling portion configured to optically couple at least a portion of an optical wave propagating through the coupling waveguiding structure into the first CWS, and a second optical coupling portion configured to optically couple at least a portion of an optical wave propagating through the coupling waveguiding structure into the first CWS. A first absorbing structure is in optical communication with the first CWS. Circuitry is configured to detect optical waves at least partially absorbed by the first absorbing structure. The coupling waveguiding structure is configured to guide optical waves along a path outside the one or more CWSs.

### CROSS-REFERENCE TO RELATED APPLICATION(S)

This application claims priority to and the benefit of U.S. Provisional Application Serial No. 63/720,418, entitled “CONFIGURING WAVEGUIDING STRUCTURES FOR DETECTING OPTICAL WAVES,” filed November 14, 2024, the entire disclosure of which is incorporated herein by reference.

### TECHNICAL FIELD

This disclosure relates to configuring waveguiding structures for detecting optical waves.

### BACKGROUND

Chip-scale devices comprising integrated circuits (ICs) have applications ranging from electronics to optical connectivity. Increasing demand for integrated circuit devices has driven advancements in their operating capabilities, physical size, and reliability alongside optimizations in manufacturing processes including production and device testing. Some IC devices can comprise electronic components configured to manipulate or transmit electric signals while other IC devices can comprise photonic structures or components configured to guide or manipulate electromagnetic waves. Some IC devices can comprise optical waveguiding structures or optical circuits configured to guide optical waves in the optical wavelength region of the electromagnetic spectrum. Some electromagnetic waves have a spectrum that has a peak wavelength that falls in a particular range of optical wavelengths (e.g., between about 100 nm to about 1 mm, or some subrange thereof), also referred to as optical waves, light waves, or simply light.

### SUMMARY

In one aspect, in general, an apparatus for detecting optical waves comprises: one or more closed-loop waveguiding structures (CWSs) formed from a core material, each CWS configured to guide optical waves along a closed-loop path, including a first CWS; a coupling waveguiding structure formed from the core material, the coupling waveguiding structure comprising a first optical coupling portion configured to optically couple at least a portion of an optical wave propagating through the coupling waveguiding structure into the first CWS, and a second optical coupling portion configured to optically couple at least a portion of an optical wave propagating through the coupling waveguiding structure into the first CWS; a first absorbing structure in optical communication with the first CWS; and circuitry configured to detect optical waves at least partially absorbed by the first absorbing structure; wherein the coupling waveguiding structure is configured to guide optical waves along a path outside the one or more CWSs.

Aspects can include one or more of the following features.

The first optical coupling portion and the second optical coupling portion are each configured to couple a respective percentage of electromagnetic power relative to a total electromagnetic power associated with an optical wave propagating through the coupling waveguiding structure into the first CWS.

The first optical coupling portion is configured to couple a respective percentage of electromagnetic power that is greater than 40% relative to a total electromagnetic power of an optical wave propagating through the coupling waveguiding structure into the first CWS.

The second optical coupling portion is configured to couple a respective percentage of electromagnetic power that is greater than 90% relative to a total electromagnetic power of an optical wave propagating through the coupling waveguiding structure into the first CWS.

The first optical coupling portion and the second optical coupling portion are each configured to couple a respective percentage of electromagnetic power relative to a total electromagnetic power associated with an optical wave propagating through the coupling waveguiding structure into the first CWS based at least in part on one or more optical wavelengths associated with the optical wave.

The one or more CWSs further comprises a second CWS, the coupling waveguiding structure further comprises a third optical coupling portion configured to optically couple at least a portion of an optical wave propagating through the coupling waveguiding structure into the second CWS, and a fourth optical coupling portion configured to optically couple at least a portion of an optical wave propagating through the coupling waveguiding structure into the second CWS.

The first CWS and the second CWS are distributed along a first axis, the first optical coupling portion and the second optical coupling portion are distributed along a second axis that is perpendicular to the first axis, and the third optical coupling portion and the fourth optical coupling portion are distributed along a third axis that is substantially parallel to the second axis.

The apparatus further comprises a second absorbing structure in optical communication with the second CWS.

The circuitry is further configured to detect optical waves at least partially absorbed by the second absorbing structure.

The circuitry comprises a plurality of metal contacts arranged in a first layer that is substantially coplanar with a first plane, a conducting material within a second layer that is substantially coplanar with a second plane that is parallel to the first plane, one or more doped portions of the core material, where the one or more CWSs are formed from the one or more doped portions of the core material, and a plurality of vias connecting each metal contact of the plurality of metal contacts to the conducting material in the second layer or the one or more doped portions of the core material, where each via of the plurality of vias extends along a respective axis that is perpendicular to the first plane.

The first CWS forms a curve that encircles at least a first via of the plurality of vias and the second CWS forms a curve that encircles at least a second via of the plurality of vias.

The first optical coupling portion and the second optical coupling portion are each configured to couple a respective percentage of electromagnetic power relative to a total electromagnetic power associated with an optical wave propagating through the coupling waveguiding structure into the first CWS, and the third optical coupling portion and the fourth optical coupling portion are each configured to couple a respective percentage of electromagnetic power relative to a total electromagnetic power associated with an optical wave propagating through the coupling waveguiding structure into the second CWS.

A first portion of the coupling waveguiding structure between the first optical coupling portion and the third optical coupling portion is configured to provide a predetermined optical delay to an optical wave propagating through the first portion of the coupling waveguiding structure, a second portion of the coupling waveguiding structure between the third optical coupling portion and the fourth optical coupling portion is configured to provide a predetermined optical delay to an optical wave propagating through the second portion of the coupling waveguiding structure, and a third portion of the coupling waveguiding structure between the fourth optical coupling portion and the second optical coupling portion is configured to provide a predetermined optical delay to an optical wave propagating through the third portion of the coupling waveguiding structure.

At least a portion of the coupling waveguiding structure between the first optical coupling portion and the second optical coupling portion is configured to provide a predetermined optical delay to an optical wave propagating through the portion of the coupling waveguiding structure.

The core material comprises silicon.

The first absorbing structure comprises a material associated with a higher refractive index than a refractive index associated with the core material.

The optical communication between the first absorbing structure and the first CWS comprises an evanescent coupling between an optical mode associated with the first CWS and an optical mode associated with the first absorbing structure.

The first absorbing structure comprises an absorbing material forming a layer over the first CWS.

The absorbing material comprises germanium.

In another aspect, in general, a method comprises: forming one or more closed-loop waveguiding structures (CWSs) from a core material, each CWS configured to guide optical waves along a closed-loop path, including a first CWS; forming a coupling waveguiding structure from the core material, the coupling waveguiding structure comprising a first optical coupling portion configured to optically couple at least a portion of an optical wave propagating through the coupling waveguiding structure into the first CWS, and a second optical coupling portion configured to optically couple at least a portion of an optical wave propagating through the coupling waveguiding structure into the first CWS; forming a first absorbing structure in optical communication with the first CWS; and configuring circuitry to detect optical waves at least partially absorbed by the first absorbing structure; wherein the coupling waveguiding structure is configured to guide optical waves along a path outside the one or more CWSs.

Aspects can have one or more of the following advantages.

In some examples, a racetrack / ring high speed photodiode architecture can lengthen the photo-sensitive path without altering RC junction properties. In some examples, a racetrack photodiode configuration can be associated with an anti-return configuration of light injection using a directional coupling strategy and a ring. Some devices can comprise homogeneous metallization contact process bearing opening on Si only. Some devices can use intrinsic germanium sandwiched between doped silicon in a horizontal configuration to generate a hetero-structured PIN diode with an index contrast between the photodetection and contact regions. Some configurations can allow for complex combinations of directional couplers and/or rings to increase responsivity and speed. Some configurations can allow for accessible wavelength tuning of the device using a dedicated directional coupling strategy.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are schematic diagrams of an example device configured as a photodetector.

FIGS. 2A-2C are schematic diagrams of an example device configured as a photodetector.

FIG. 2D is a schematic diagram of optical coupling in an example device.

FIG. 3 is a schematic diagram of a portion of an example device configured as a photodetector.

FIG. 4 is a schematic diagram of a top view of an example device comprising closed-loop waveguiding structures.

FIGS. 5A-5B are schematic diagrams of top views of example devices comprising closed-loop waveguiding structures.

FIG. 6 is a prophetic plot of numerical simulations associated with configuring devices.

FIG. 7 is a schematic diagram of a top view of an example device comprising closed-loop waveguiding structures.

FIGS. 8A-8B are schematic diagrams of an example device configured as a photodetector.

FIGS. 9A-9B are schematic diagrams of cutaway views of an example device.

FIG. 10 is a schematic diagram of a flowchart of an example method.

### DETAILED DESCRIPTION

Some IC devices can comprise devices configured to transform optical waves into electronic or radiofrequency (RF) signals. Such devices can be referred to as photodiodes. Some integrated photodiode devices in silicon photonics can be made up of a segment of germanium on top of a silicon waveguide. The optical signal propagating through the silicon waveguide can be evanescently coupled from the silicon waveguide to the germanium, resulting in photo-carrier generation. The generated carriers can then be collected using electrodes in electrical communication with a doped semiconductor structure having a diode configuration (e.g., a PIN diode configuration with an undoped intrinsic region between p-type doped and n-type doped regions) under a reverse bias.

Without using the method disclosed herein, some photodiodes can be made up of a linear segment of germanium on top of a silicon waveguide. In some examples, device operation can be limited at high-speed by the transit time of the photo-carriers, the access resistance of the diode and the capacitance of the depleted region. In some implementations, to achieve higher speed, the carrier path can be shortened, the access resistance reduced, and the junction capacitance lowered. These modifications can also be associated with reducing the Germanium (Ge) length and cross-section. In some examples, reducing Ge length can be associated with a reduction in the device responsivity, which can complicate circuit operation.

In contrast, using the method disclosed herein, a photodiode can be configured to facilitate high-speed RF performance while not compromising on the device responsivity. In some examples, this configuration can comprise (1) folding the device in a ring configuration to obtain a closed-loop structure, (2) developing a reliable and robust architecture to couple light inside the ring and (3) fabricating a junction configuration for photo-carrier collection.

In some implementations, an integrated circuit architecture can be formed as part of an apparatus. An apparatus can be implemented in various configurations, including as a single device or as a combination of one or more devices that collectively perform the functions of a system or subsystem within a larger system. In some examples, the one or more devices can include an integrated circuit that includes various photonic devices, also referred to as a photonic integrated circuit, and/or an integrated circuit that includes a variety of other functional modules on the same chip or die, also referred to as a system-on-a-chip, or the one or more devices can include a combination separate chips that have been integrated together in any of a variety of arrangements (e.g., 2D, 2.5, 3D integration).

In some implementations, a system can be formed from one or more integrated circuit (IC) chips comprising portions of a circuit architecture. Some circuit architectures can be distributed across multiple chips or consolidated onto a single chip. Some chips can comprise multiple layers of material. In some examples, portions of a circuit architecture can be formed across several layers of devices.

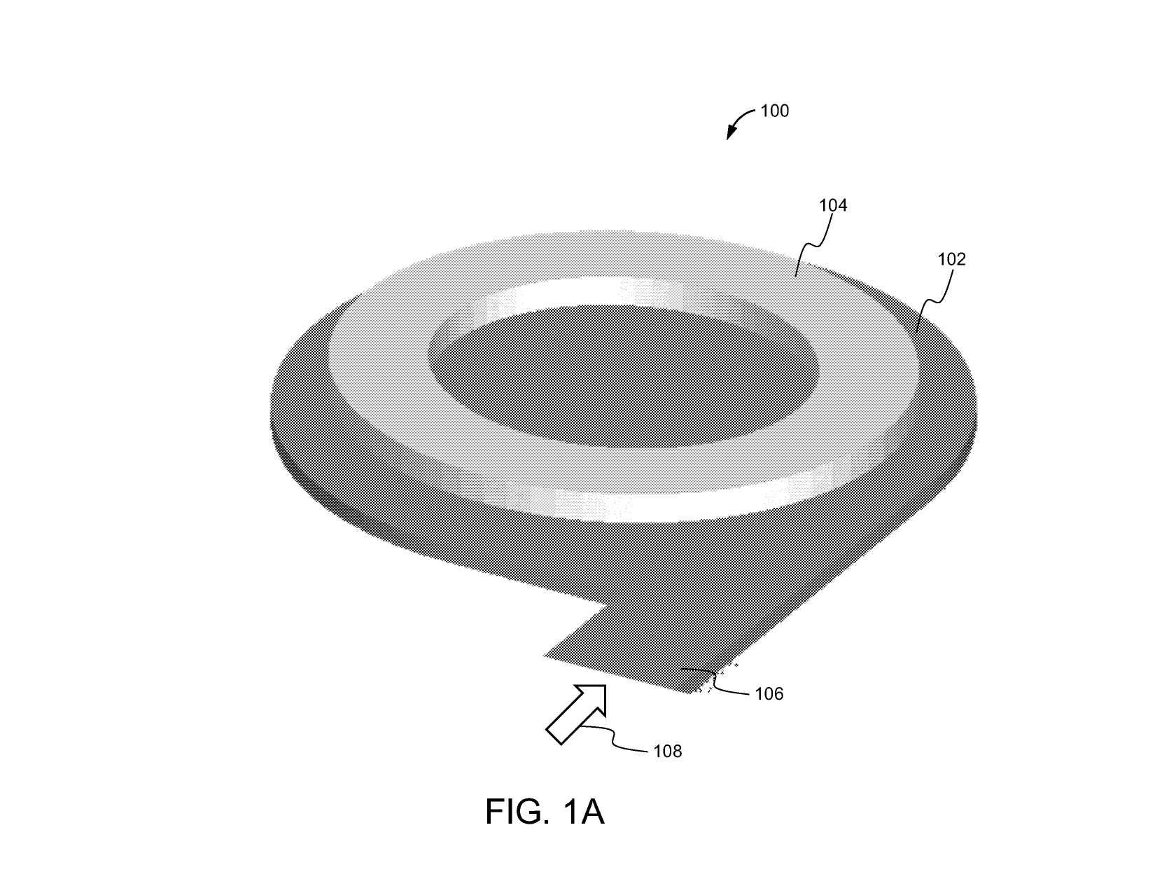

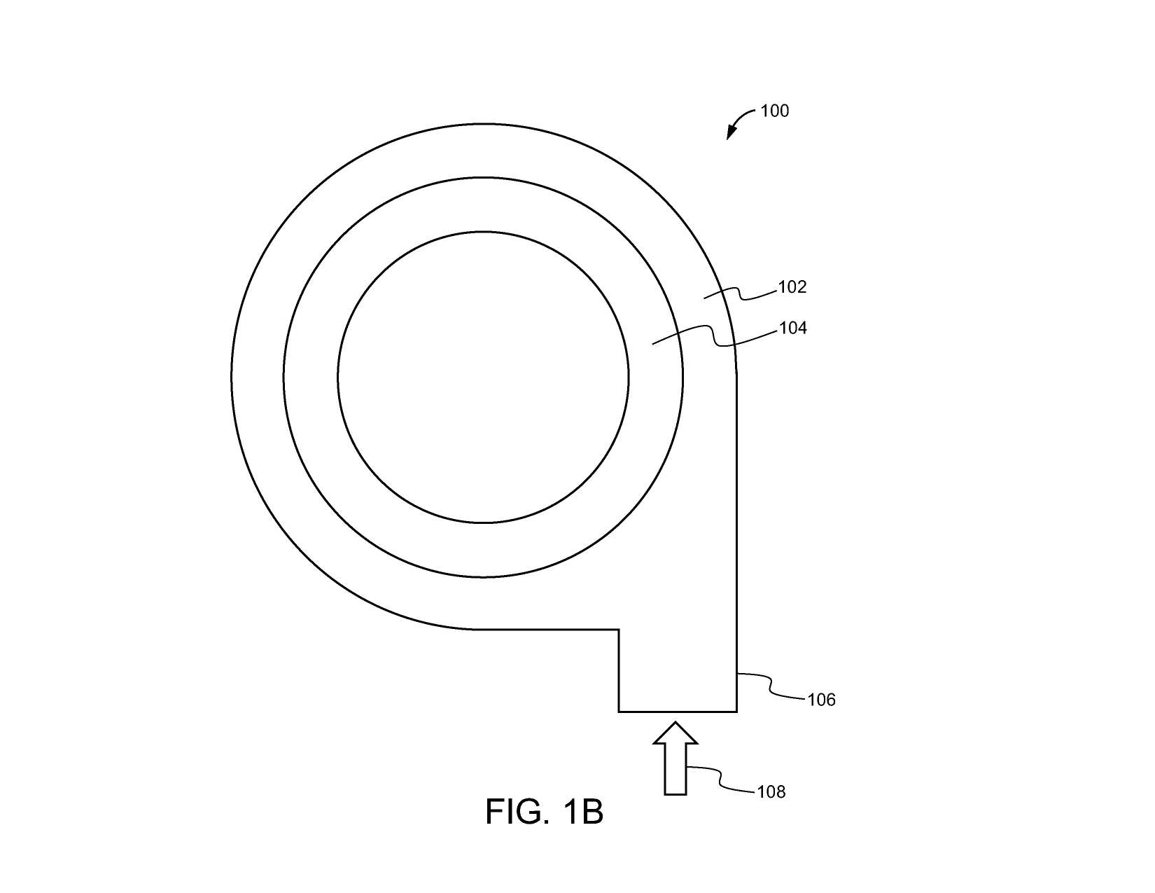

A perspective view of an example configuration of a photodiode device 100 is shown in FIG. 1A while a top view of the photodiode device 100 is shown in FIG. 1B. The photodiode device 100 comprises a substrate 102 formed from a core material, i.e., silicon. The photodiode device 100 further comprises an absorbing structure 104 in optical communication with the substrate 102. In some implementations, the first absorbing structure can be formed from a material such as germanium such that the photodiode device 100 comprises a germanium ring structure grown on a silicon slab. The photodiode device 100 further comprises an optical coupler 106, i.e., an optical input port. In some examples, a substrate 102 can be patterned such that an optical input port can be connected to a waveguide. An optical wave 108 can be coupled into optical waveguiding structures on the substrate 102 via the optical coupler 106.

In other words, some optical waveguiding structures can be formed from a core material of a substrate.

In some implementations, germanium can have a higher refractive index than silicon (e.g., over some wavelength intervals). An optical signal, such as the optical wave 108, that is coupled inside the absorbing structure 104, i.e., a ring, can remain confined within the absorbing structure 104 and start spinning until the optical signal is absorbed by the material of the absorbing structure, i.e., germanium. In other words, an absorbing material of the absorbing structure can absorb an optical signal. In some examples, the ring circumference can be small because the photodetection path can be theoretically infinite. In some examples, the absorption coefficient of germanium can allow for at most three or four turns before the signal gets fully absorbed, even for low absorption wavelengths, such as the L-band in telecommunication. For example, at a wavelength of 1550 nm, 80% of the signal can be absorbed within a path of 5µm for a device bearing a targeted cross-section. In some examples, a targeted ring cross section can be ≥ 12µm. In some implementations, complete resonance does not occur and the device optical bandwidth can depend only on a directional coupler associated with the device, which can be made very large bandwidth. Consequently, the device can be designed to be colorless within a given telecommunication band.

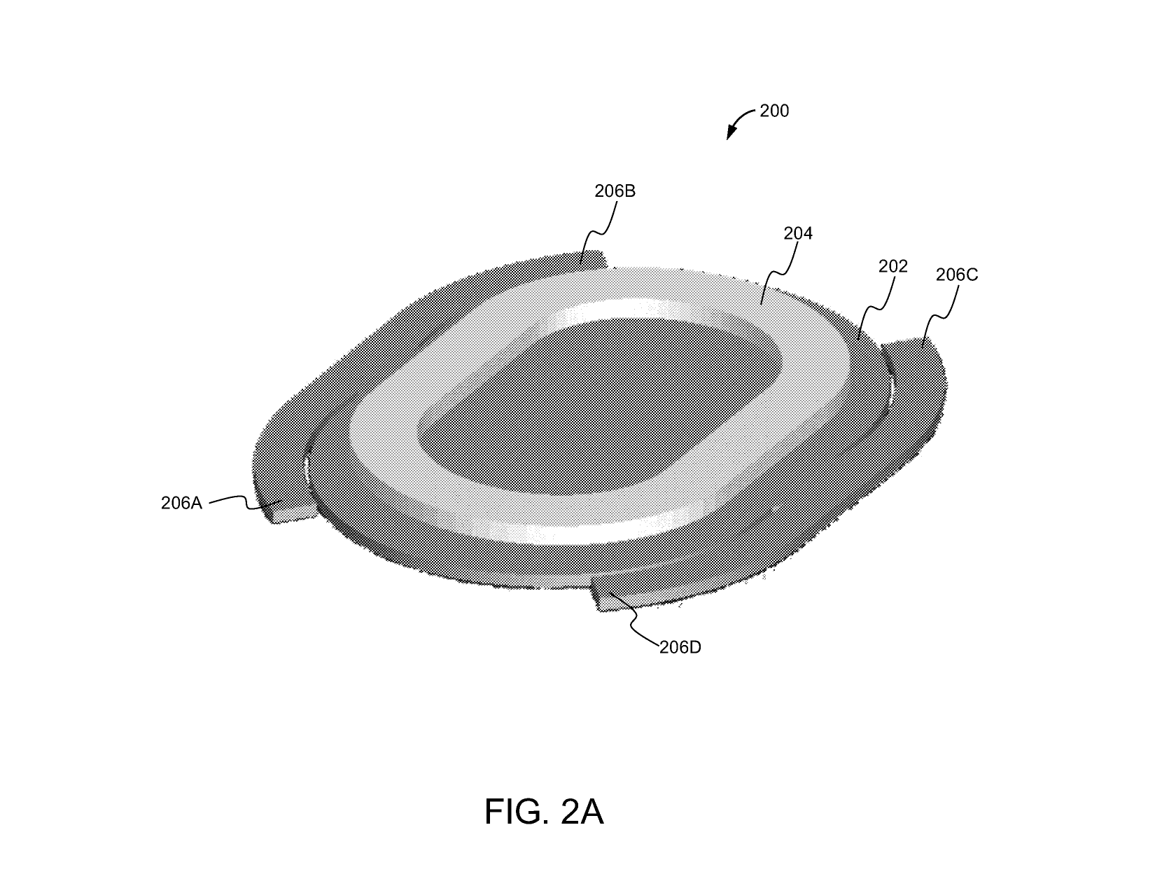

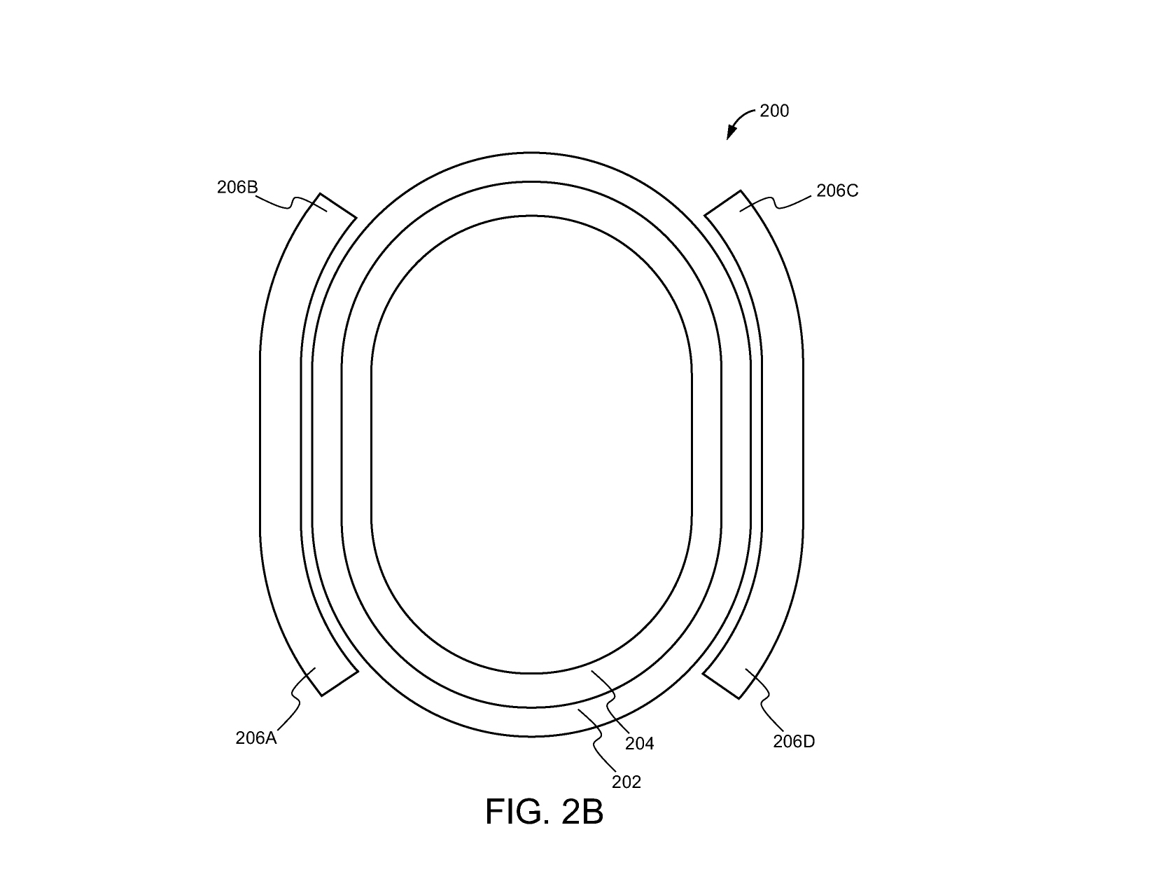

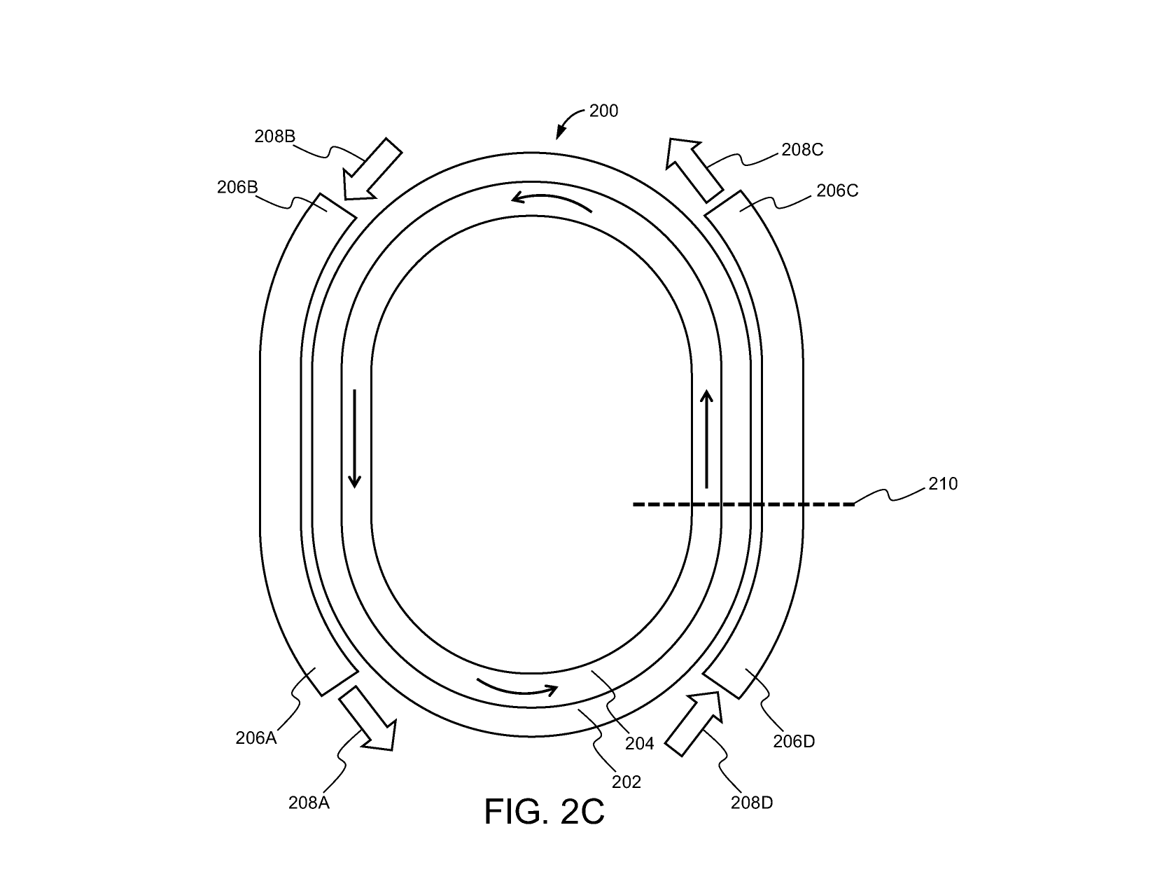

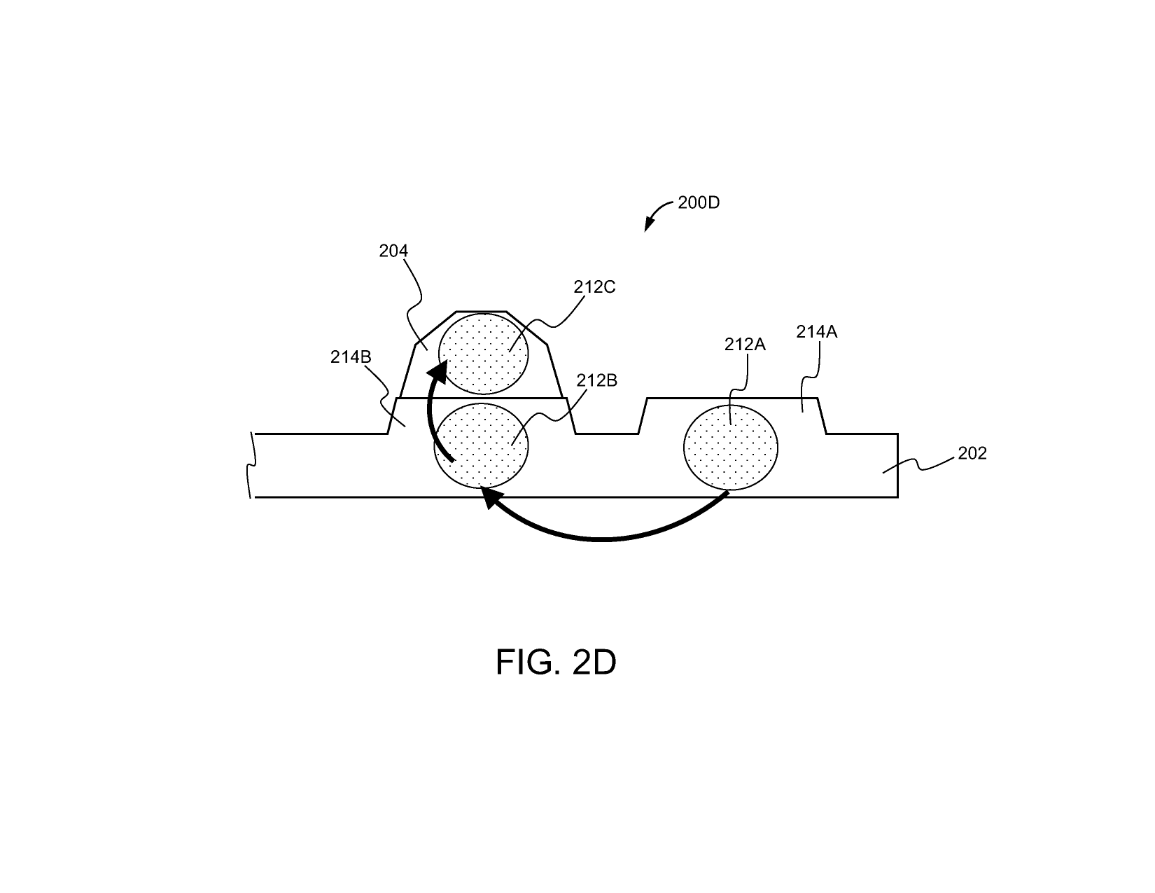

Some photodiodes can comprise more refined device architectures wherein a ring is elongated in the form of a racetrack, i.e., an oval shape comprising two or more linear portions. In some implementations, including these linear portions can allow for better coupling of an optical signal into an absorbing structure. A perspective view of example device 200 that can be used as a photodiode is depicted in FIG. 2A, while a top view of the device 200 is shown in FIG. 2B and FIG. 2C. As shown in FIGS. 2A-2C, the device 200 comprises a substrate 202 formed from a core material. The device 200 further comprises an absorbing structure 204 in optical communication with the substrate 202. The device 200 further comprises a plurality of optical ports, i.e., an optical port 206A, an optical port 206B, an optical port 206C, and an optical port 206D. As shown in FIGS. 2A-2C, the plurality of optical ports 206A-206D are formed from portions of an optical waveguide or optical waveguiding structure. The optical port 206A is connected to the optical port 206B by a portion of an optical waveguiding structure while the optical port 206C is connected to the optical port 206D by a portion of an optical waveguiding structure. In contrast to the device shown in FIGS. 1A-1B, the device 200 shown in FIGS. 2A-2B includes four optical ports.

Some optical ports can be configured as input ports and some ports can be configured as output ports. By way of example, FIG. 2C depicts a configuration wherein an optical wave 208B is provided to the optical port 206B and an optical wave 208D is provided to the optical port 206D. FIG. 2C further depicts the optical port 206A providing an optical wave 208A and the optical port 206C providing an optical wave 208C. Arrows depicting directions of propagation through the absorbing structure 204 are also shown. In this example, the device 200 comprises two input ports and two rejection ports.

Optical signals provided to one or more optical ports of the plurality of optical ports 206A-206D can be coupled into the substrate 202. A side view of a portion 200D of the device 200 along a plane 210 is shown in FIG. 2D. The portion 200D highlights an example optical injection strategy. As shown in FIG. 2D, an optical mode 212A associated with an optical wave propagates in a first waveguiding structure 214A formed from the substrate 202. A portion of the optical wave is coupled into the optical mode 212B associated with an optical wave propagating in a second waveguiding structure 214B formed from the substrate 202. In this example, the optical wave is coupled between the first waveguiding structure 214A and the second waveguiding structure 214B by directional coupling. As shown in FIG. 2D, the absorbing structure 204 is formed on the second waveguiding structure 214B. Such implementations can allow for a portion of an optical wave propagating in the second waveguiding structure 214B to be evanescently coupled from the second waveguiding structure 214B into the absorbing structure 204. An example optical mode 212C associated with an optical wave propagating in the absorbing structure 204 is shown. As shown in FIG. 2D, the directional coupling section comprises a rib waveguide configuration. In some examples, a directional coupling section can comprise a rib waveguide configuration or a strip (channel) waveguide configuration.

In other words, as shown in FIG. 2D, an optical injection strategy can comprise two steps: (1) The optical signal coming from the waveguide approaches the device and can couple within the silicon slab using a directional coupling strategy. (2) The signal which is confined in the rib portion of the device silicon slab can then be coupled to germanium evanescently. In some examples, the coupling strategy can be associated with one or more of the following advantages: (1) The racetrack round-trip length can be selected to determine a balance between RF performance and potential parasitic interferences at given wavelengths. (2) The directional couplers can be designed to be large or narrow optical bandwidth and thus behave as wavelength tuners. (3) Directional coupling can also selectively filter out parasitic noise which is in the form of higher order optical modes. (4) The overall coupling strategy can allow for low optical return loss (ORL) because there are no reflection interface planes.

While the example shown in FIG. 2C depicts the optical port 206D and the optical port 206B as receiving optical waves while the optical port 206A and the optical port 206C are providing optical waves such that the optical waves propagate through the absorbing structure 204 in a counter-clockwise direction, other configurations are also possible. For instance, the optical port 206A and the optical port 206C can be configured to receive optical waves while the optical port 206B and the optical port 206D can provide optical waves. Such configurations can allow the optical waves to propagate through the absorbing structure 204 in a clockwise direction.

In other words, as shown in FIG. 2C, the device 200 comprises two optical ports, i.e., the optical port 206B and the optical port 206D, that are configured as input ports. An optical signal can be injected through those optical ports and coupled to an optical waveguiding structure on which an absorbing structure 204 is formed. Any light that is not coupled into the optical waveguiding structure on which the absorbing structure 204 is formed can remain in the waveguide and travel to the optical port 206A or the optical port 206C.

In some implementations, fabrication processes or methods of fabrication can result in variations in device performance. For instance, fabrication process drifts can potentially alter the coupling coefficient. In some implementations, a control on that portion of the signal which is not coupled can be included in a device. For instance, optical absorbing dumps can be positioned at the optical port 206A or the optical port 206C such that the residual signal does not result in background noise for any device of the whole circuit.

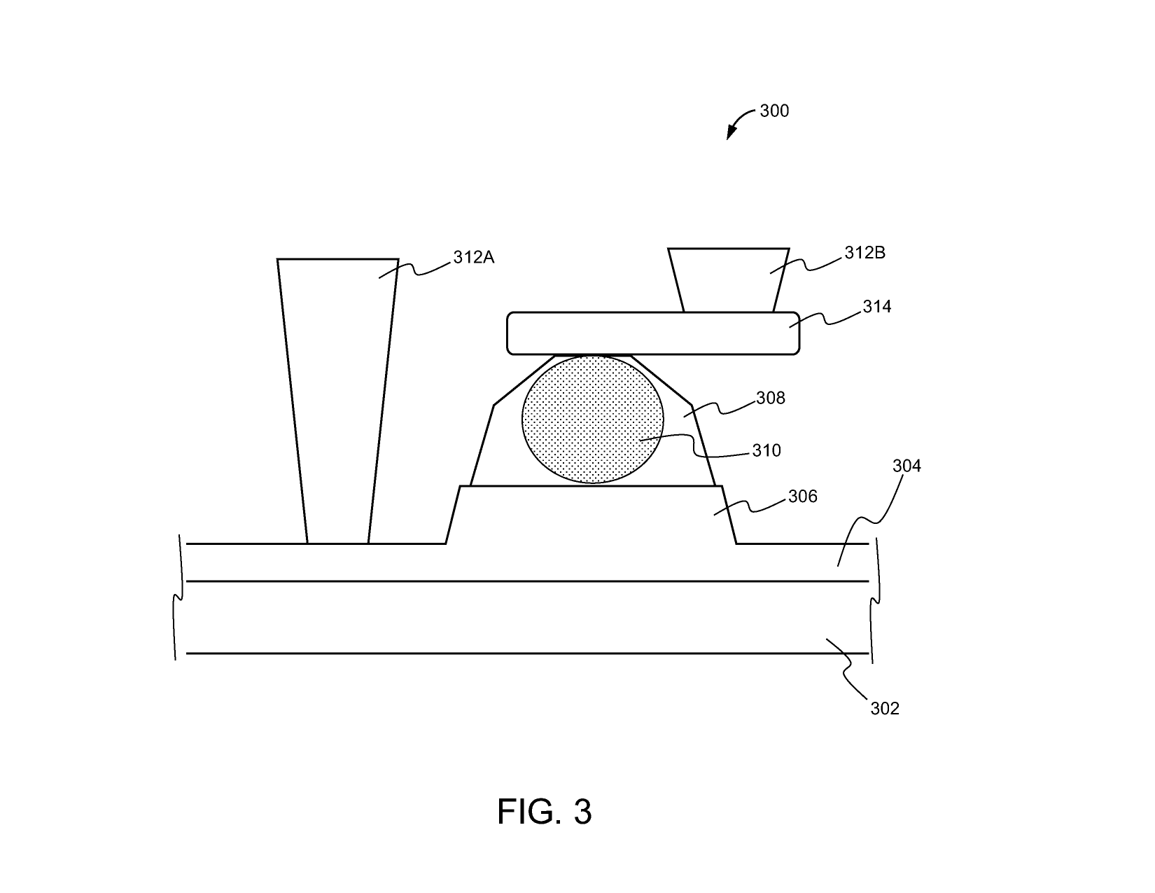

In some examples, circuitry can be configured to detect optical waves at least partially absorbed by an absorbing structure formed from a material such as germanium. In some examples, this circuitry can comprise an electrical design. A side view of a portion 300 of an example device highlighting electrical design is shown in FIG. 3. The portion 300 comprises a substrate 302. The substrate 302 comprises a doped portion 304 comprising dopants mixed within a material of the substrate 302. A waveguiding structure 306 is formed from a portion of the substrate 302. An absorbing structure 308 is formed on the waveguiding structure 306. An optical mode 310 associated with an optical wave propagating through the absorbing structure 308 is shown. The portion 300 further comprises circuitry configured to detect optical waves at least partially absorbed by the absorbing structure 308. In this example, the circuitry comprises a first electrode 312A and a second electrode 312B. The first electrode 312A is in electrical communication with the doped portion 304. The second electrode 312B is in electrical communication with the absorbing structure 308 via a layer 314 of a material.

In some implementations, the substrate 302 can comprise a material such as silicon, the absorbing structure can comprise a material such as germanium, and the layer 314 can comprise a material such as silicon or poly-silicon. In other words, the portion 300 of the device comprises a configuration in which the germanium photo-sensitive section is trapped in a sandwich configuration of two doped silicon layers. In some examples, the bottom electrode can be a implanted silicon slab, while the top electrode can be a deposited layer of polysilicon. Consequently, the germanium section can remain intrinsic and can be used for carrier generation only. The resulting device architecture is a pin junction which is electrically addressed using metallization.

In other words, some implementations can be configured such that the germanium layer, i.e., an absorbing structure, is not in contact with metal. In some examples, this lack of metal contact can be associated with benefits including (1) the process can be easier to achieve, (2) less optical loss due to interaction with metal, and (3) dark current can be lower.

The proposed device architecture can allow for compact circuit configurations that can be used in high-speed telecommunication systems. Without using the methods disclosed herein, as mentioned, a device can bear a compact electrical junction which can lower the capacitance and result in lower RF bandwidth drop. Some transceivers can be associated with higher RF bandwidth specifications such that RF engineering is not enough to accomplish these specifications.

In contrast, an advantage associated with using the methods disclosed herein can be that high optical-index Ge photo-sensitive material can be sandwiched between two lower optical-index Si layers. Consequently, the optical signal can readily move within the Ge material and remain confined in the Ge material until absorbed. Thus, the Ge layer can be made very thin so that the device transit time can also be reduced, making RF bandwidth threshold even higher.

Without using the methods disclosed herein, some receiver systems can operate at high optical power to compensate for RF drop. In some systems, higher RF bandwidth specification can be associated with higher optical powers. However, a photo-sensitive port can be limited in optical power because saturation can occur, and this limitation can have consequences on both RF bandwidth and device reliability. In some devices, the optical signal can be split in two and addressed at the two extremities of the linear photodiode. As mentioned, the disadvantage of such a scheme is that a fraction of the signal can travel through and then be injected in the opposite port, thus generating an associated optical return loss.

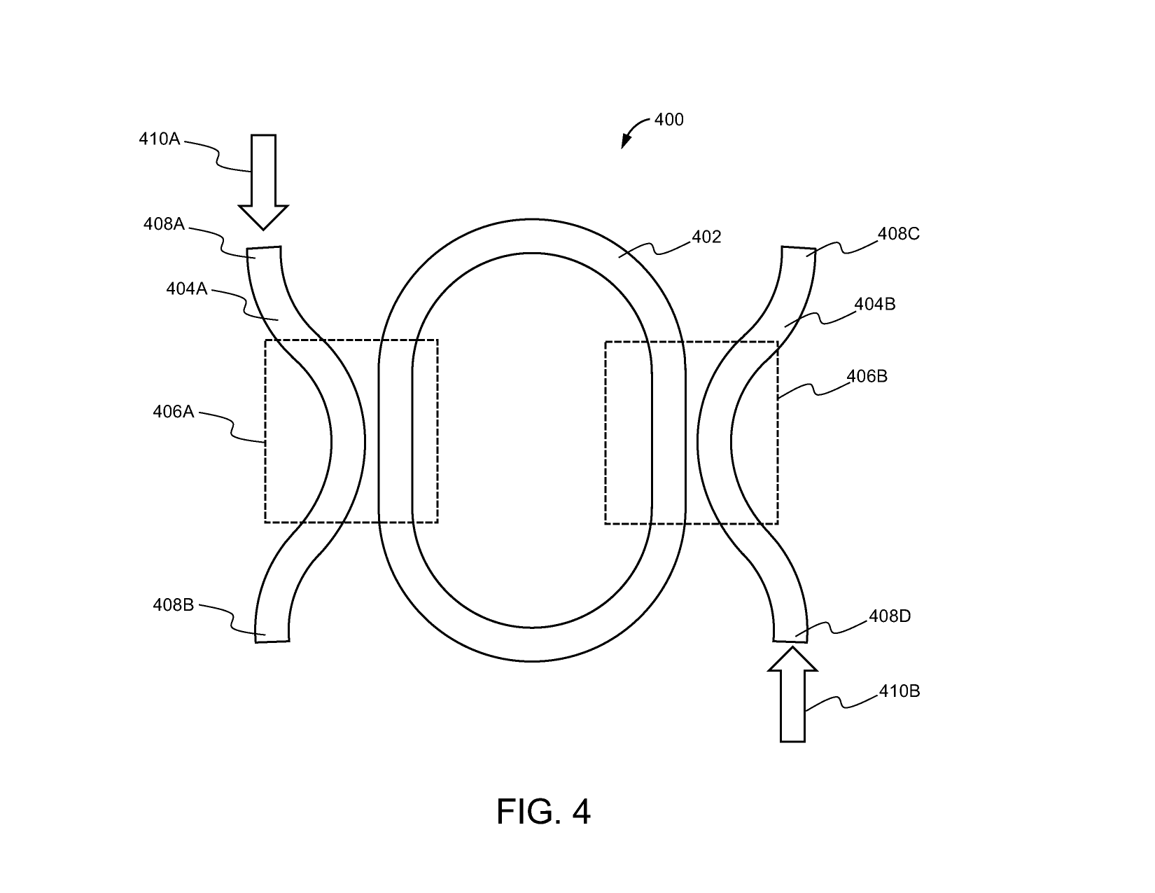

In contrast, using the method disclosed herein, a device can be configured to have two optical ports which do not interfere and do not generate any return. Some devices can be comprise closed-loop waveguiding structures (CWSs) formed from a core material, where the CWSs are configured to guide optical waves along a closed-loop path. FIG. 4 depicts a top view of an example device 400. The device 400 comprises a CWS 402 formed from a core material. In some examples, an absorbing structure can be in optical communication with the CWS 402, i.e., formed as a layer on the CWS 402. A coupling waveguiding structure 404A and a coupling waveguiding structure 404B are each configured to guide optical waves along paths outside the CWS 402. The coupling waveguiding structure 404A comprises an optical coupling portion 406A that is configured to optically couple at least a portion of an optical wave propagating through the coupling waveguiding structure 404A into the CWS 402. The coupling waveguiding structure 404A further comprises an optical port 408A and an optical port 408B. Optical waves can be provided to either of the optical port 408A or the optical port 408B. In this example, an optical wave 410A is provided to the optical port 408A. The coupling waveguiding structure 404B comprises an optical coupling portion 406B that is configured to optically couple at least a portion of an optical wave propagating through the coupling waveguiding structure 404B into the CWS 402. The coupling waveguiding structure 404B further comprises an optical port 408C and an optical port 408D. Optical waves can be provided to either of the optical port 408C or the optical port 408D. In this example, an optical wave 410B is provided to the optical port 408D.

Some implementations of a compact racetrack configuration can be configured such that an optical signal is not split beforehand. Some compact racetrack configurations can comprise optical coupling portions configured to optically couple a portion of an optical wave. Some optical coupling portions can comprise directional couplers engineered to have different coupling ratios such that no other splitting is necessary.

In some implementations, a coupling portion can be configured as a large bandwidth coupling portion. Such implementations can comprise an adiabatic taper, where a first portion of the coupling portion is wider than a second portion of the coupling portion. In other words, a width of a waveguide in a coupling portion can vary along the coupling length.

In some implementations, an absorbing structure formed on a CWS can serve as a monitoring photodiode. In such implementations, a coupling portion can be configured to couple a small percentage of an optical power of an optical wave into a CWS. For instance, a coupling portion can couple 1-5% of an optical power. Such coupling portions can be referred to as a “tap.”

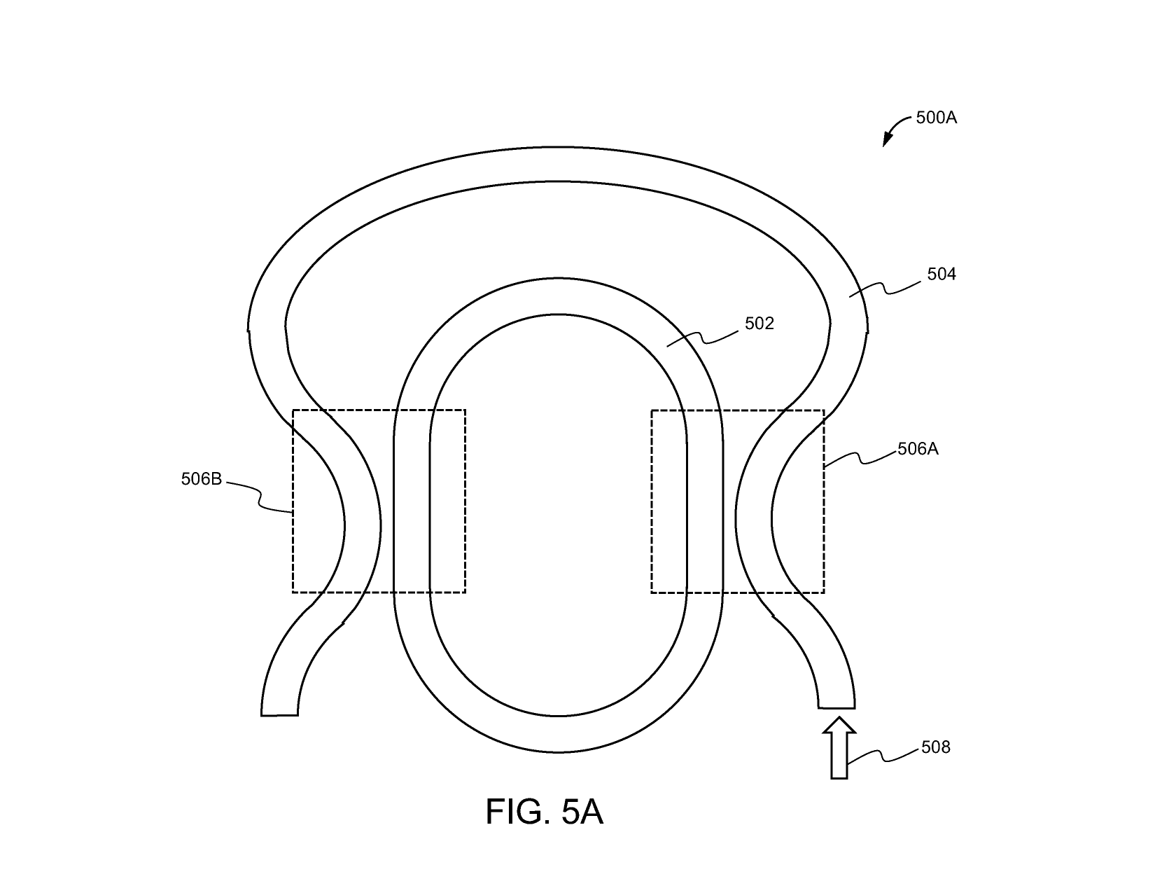

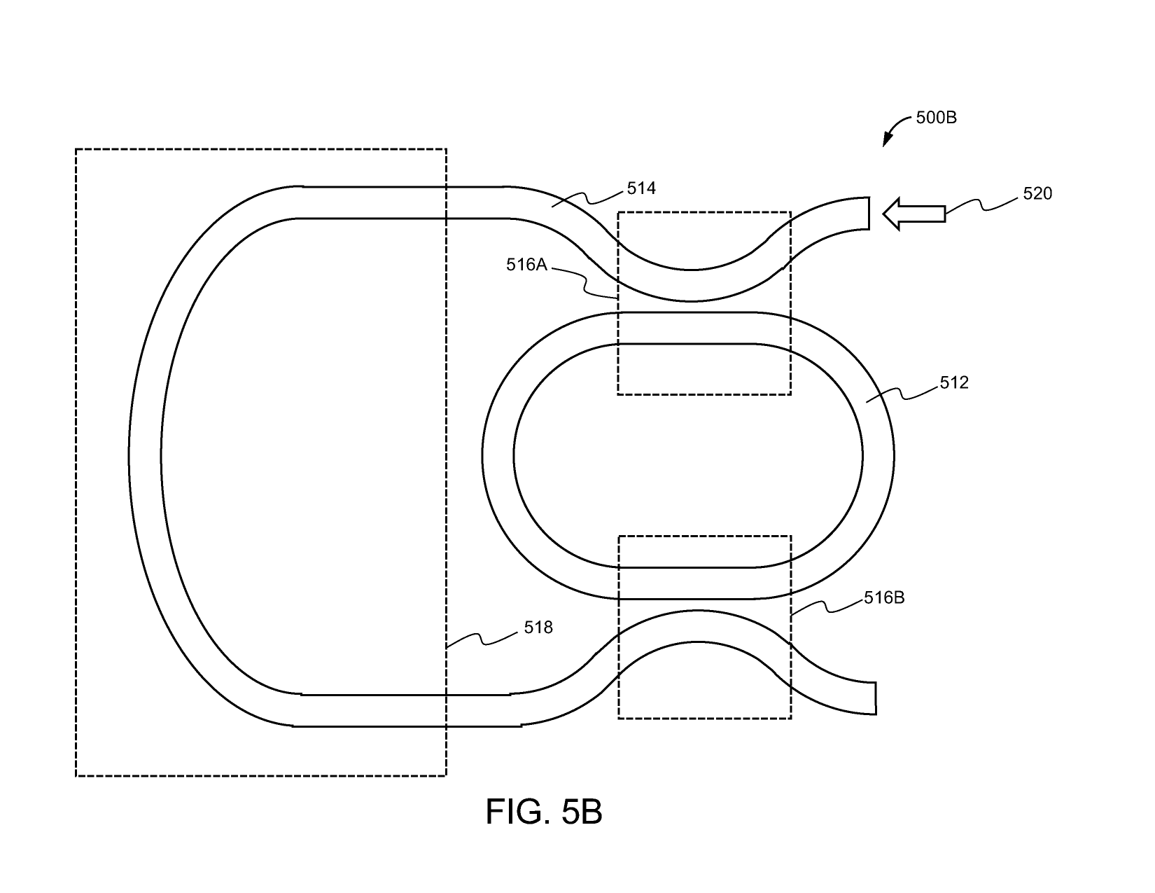

An example device 500A is shown in FIG. 5A. The device 500A comprises a CWS 502 configured to guide optical waves along a closed-loop path. In some implementations, the CWS 502 can be configured to guide optical waves such that light traverses in a unidirectional manner. Some CWSs can be formed from a core material. The device 500A also comprises a coupling waveguiding structure 504 formed from the core material. The coupling waveguiding structure 504 is configured to guide optical waves along a path outside the CWS 502. The coupling waveguiding structure 504 comprises a first optical coupling portion 506A that is configured to optically couple at least a portion of an optical wave propagating through the coupling waveguiding structure 504 into the CWS 502. The coupling waveguiding structure further comprises a second optical coupling portion 506B that is configured to optically couple at least a portion of an optical wave propagating through the coupling waveguiding structure 504 into the CWS 502. In some implementations, a first absorbing structure (not shown) can be placed in optical communication with the CWS 502, i.e., as a layer on the CWS 502. In some implementations, circuitry (not shown) can be configured to detect optical waves at least partially absorbed by the first absorbing structure. By way of example, an optical wave 508 is provided to the coupling waveguiding structure 504.

In some implementations, the first optical coupling portion 506A and the second optical coupling portion 506B can each be configured to couple a respective percentage of electromagnetic power relative to a total electromagnetic power associated with an optical wave propagating through the coupling waveguiding structure 504 into the CWS 502. In some implementations, the respective percentages can be different. For instance, the first optical coupling portion 506A can be configured to couple a respective percentage of electromagnetic power that is greater than 40% relative to a total electromagnetic power of an optical wave propagating through the coupling waveguiding structure 504 into the CWS 502. By way of example, the first optical coupling portion 506A can be configured to couple 50% optical signal into the CWS 502. The second optical coupling portion 506B can be configured to couple a respective percentage of electromagnetic power that is greater than 90% relative to a total electromagnetic power of an optical wave propagating through the coupling waveguiding structure 504 into the CWS 502. By way of example, the second optical coupling portion 506B can couple 100% of the remaining signal into the CWS 502. In this configuration, a device can behave as a two-port photodetector such that optical power can be distributed along the Ge racetrack to avoid local saturation. In other words, configuring a photodetector in this way can allow for a first portion of an optical signal to be detected by a first portion of an absorbing structure while a second portion of an optical signal is detected by a second portion of an absorbing structure.

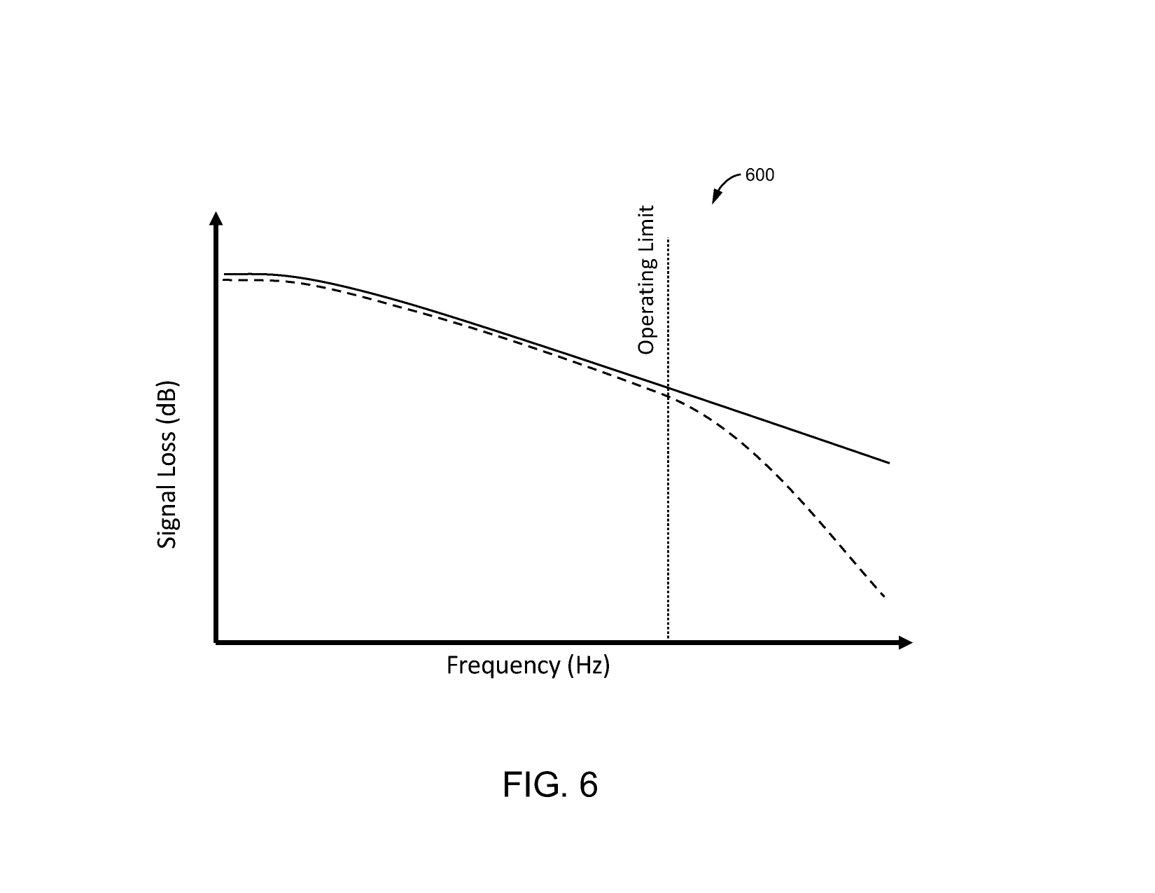

In some implementations, RF attenuation can be slow beyond the operating limit. FIG. 6 depicts a plot 600 of numerical simulations associated with dispersion in a device. In some implementations, attenuation can be improved by placing an optical delay between the two ports.

FIG. 5B depicts an example device 500B that is configured similarly to the device 500A. The device 500B comprises a CWS 512 and a coupling waveguiding structure 504. The coupling waveguiding structure 514 comprises a first optical coupling portion 516A and a second optical coupling portion 516B. A portion 518 of the coupling waveguiding structure 514 of the device 500B between the first optical coupling portion 516A and the second optical coupling portion 516B is configured to provide a predetermined optical delay to an optical wave propagating through the portion 518 of the coupling waveguiding structure 514. In this example, the optical delay is implemented by introducing a path extension between the first optical coupling portion 516A and the second optical coupling portion 516B. By way of example, an optical wave 520 is coupled into the coupling waveguiding structure 514.

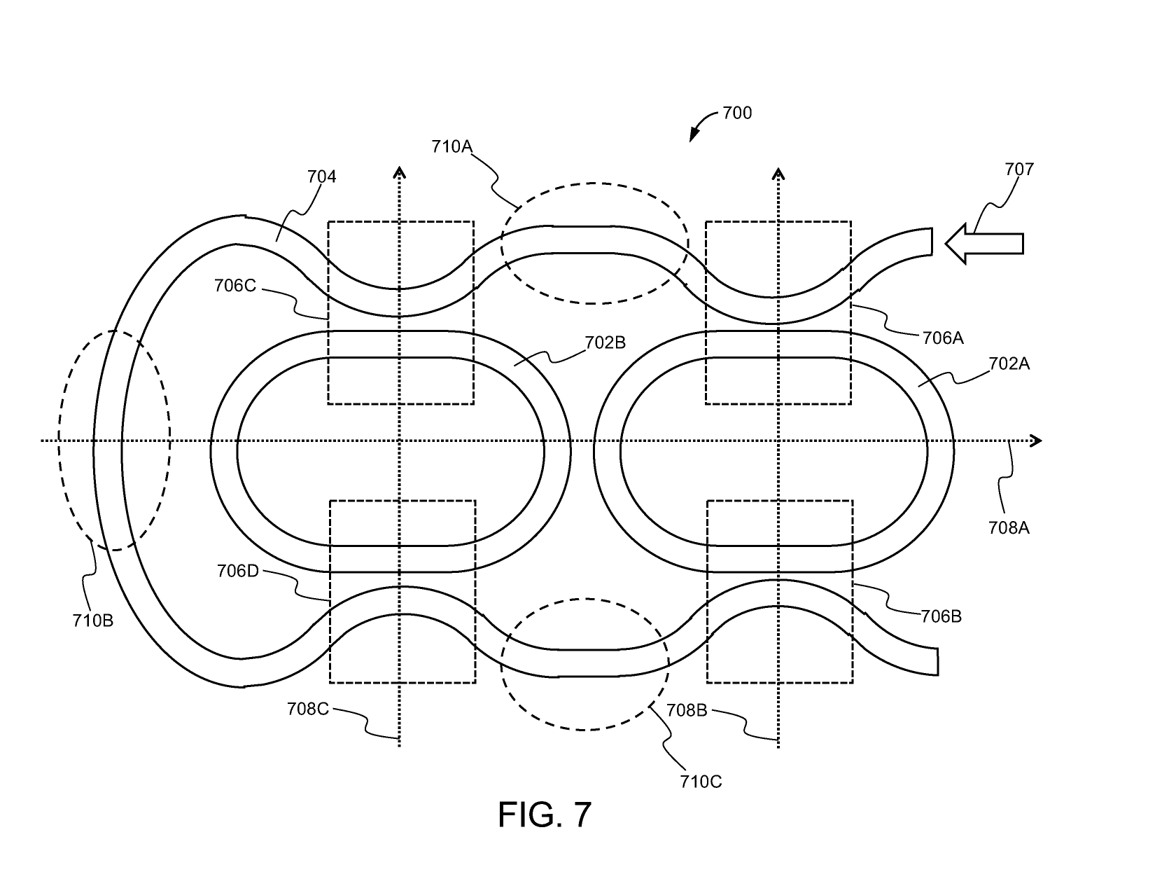

Some devices can comprise more than one photodetector racetrack. An example device 700 comprising a first CWS 702A and a second CWS 702B is shown in FIG. 7. Each of the first CWS 702A and the second CWS 702B is configured to guide optical waves along a closed-loop path. A coupling waveguiding structure 704 is configured to guide optical waves along a path outside the first CWS 702A and the second CWS 702B. The coupling waveguiding structure 704 comprises a first optical coupling portion 706A and a second optical coupling portion 706B that are each configured to optically couple at least a portion of an optical wave propagating through the coupling waveguiding structure 704 into the first CWS 702A. The coupling waveguiding structure 704 further comprises a third optical coupling portion 706C and a fourth optical coupling portion 706D that are each configured to optically couple at least a portion of an optical wave propagating through the coupling waveguiding structure 704 into the second CWS 702B. In other words, the coupling waveguiding structure 704 comprises a plurality of optical coupling portions 706A-706D. Each of the first CWS 702A and the second CWS 702B can be in optical communication with a first absorbing structure and a second absorbing structure, respectively. Each of the first absorbing structure and the second absorbing structure can be formed as a layer on the first CWS 702A and the second CWS 702B, respectively. An example optical wave 707 is provided to the coupling waveguiding structure 704.

As shown in FIG. 7, the first CWS 702A and the second CWS 702B are positioned in series. In some examples, this configuration can be associated with better power distribution and avoidance of saturation. In other words, by including more CWSs that are in contact with absorbing structures, optical power can be distributed to the CWSs for detection and measurement. In some examples, an associated directional-coupling design can allow for the same optical power to be injected in each port. Without using the methods disclosed herein, a non-loopback configuration such as a linear photodiode, even if addressed using a directional coupler, cannot lead to the same result because all the unabsorbed reflected portion of the signal can be coupled back in the input port. In contrast, using the methods disclosed herein can allow for the unabsorbed light to be rejected into the through port of the directional coupler. The device can be compact and can comprise a cathode implemented using silicided polysilicon such that electrical inter-connection can also be straight forward and compact. In some examples, this configuration can also avoid introducing any electrical phase-delay between the generated RF photocurrents which can degrade the speed performance.

Returning to FIG. 7, the first CWS and the second CWS are distributed along a first axis 708A. The first optical coupling portion 706A and the second optical coupling portion 706B are distributed along a second axis 708B that is perpendicular to the first axis. The third optical coupling portion 706C and the fourth optical coupling portion 706D are distributed along a third axis 708C that is substantially parallel to the second axis 708B.

In some examples, each optical coupling portion of the plurality of optical coupling portions 706A-706D can be configured to couple a different respective percentage of electromagnetic power propagating through the coupling waveguiding structure 704 into either the first CWS 702A or the second CWS 702B. For instance, the first optical coupling portion 706A can be configured to couple 25% of electromagnetic power, the second optical coupling portion 706B can be configured to couple 100% of electromagnetic power, the third optical coupling portion 706C can be configured to couple 33% of electromagnetic power, and the fourth optical coupling portion 706D can be configured to couple 50% of electromagnetic power.

In some multi-racetrack configurations, different optical phase delays can also be introduced at dedicated positions to provide RF fading. For instance, optical phase delays in the form of predetermined optical path lengths can be introduced to a plurality of portions 710A-710C, i.e., a portion 710A, a portion 710B, and a portion 710C, of the coupling waveguiding structure of the device 700. As shown in FIG. 7, the portion 710A is between the first optical coupling portion 706A and the third optical coupling portion 706C. The portion 710B is between the third optical coupling portion 706C and the fourth optical coupling portion 706D. The portion 710C is between the fourth optical coupling portion 706D and the second optical coupling portion 706B.

Some optical coupling portions can be configured to separate wavelengths associated with an optical wave or couple a respective percentage of electromagnetic power relative to a total electromagnetic power associated with an optical wave propagating through a coupling waveguiding structure into a CWS based at least in part on one or more optical wavelengths associated with the optical wave.

For simplicity, a scheme involving two racetracks or CWSs is demonstrated in FIG. 7, but implementations of more than two rings/racetracks can be feasible. In other words, a device can comprise a plurality of CWSs, where each CWS of the plurality of CWSs is configured to guide optical waves along a respective closed-loop path. A coupling waveguiding structure can be configured to guide optical waves along a path outside the plurality of CWSs and can be configured to couple portions of optical waves into each CWS of the plurality of CWSs.

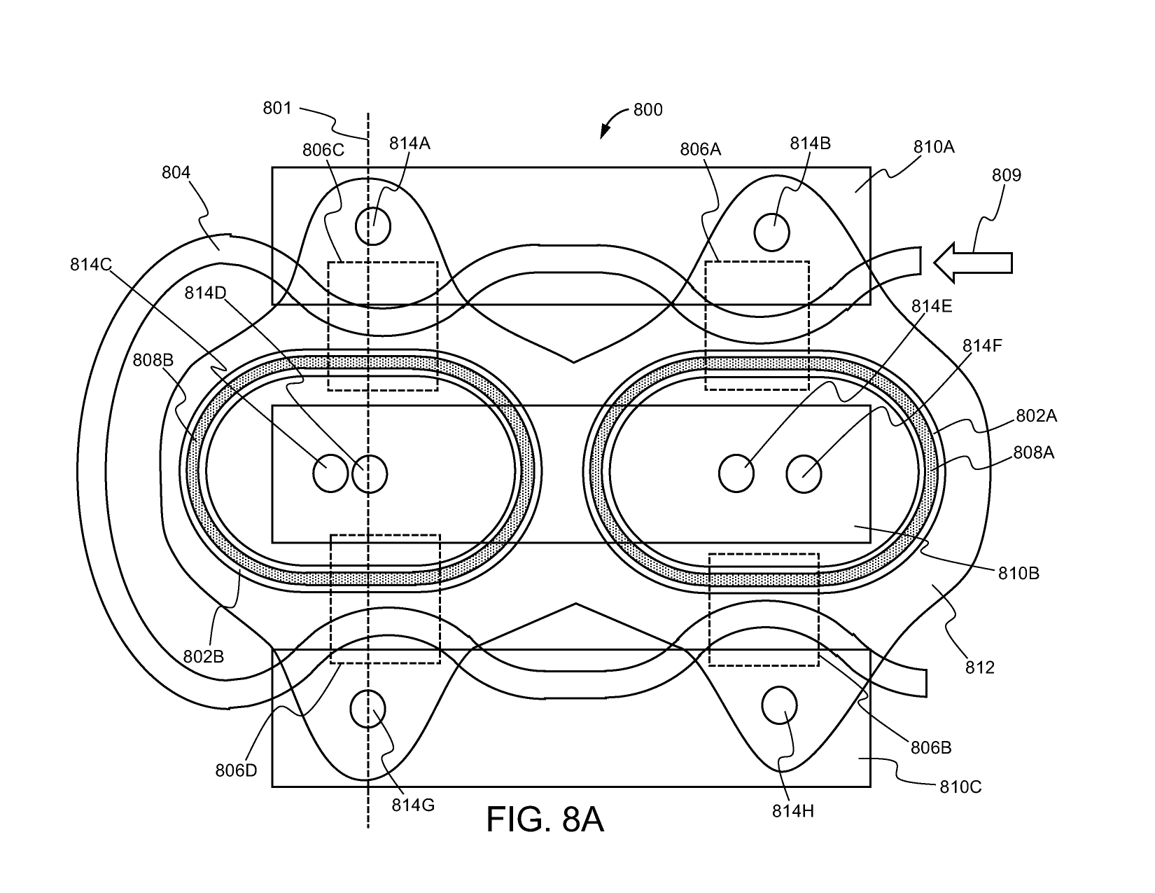

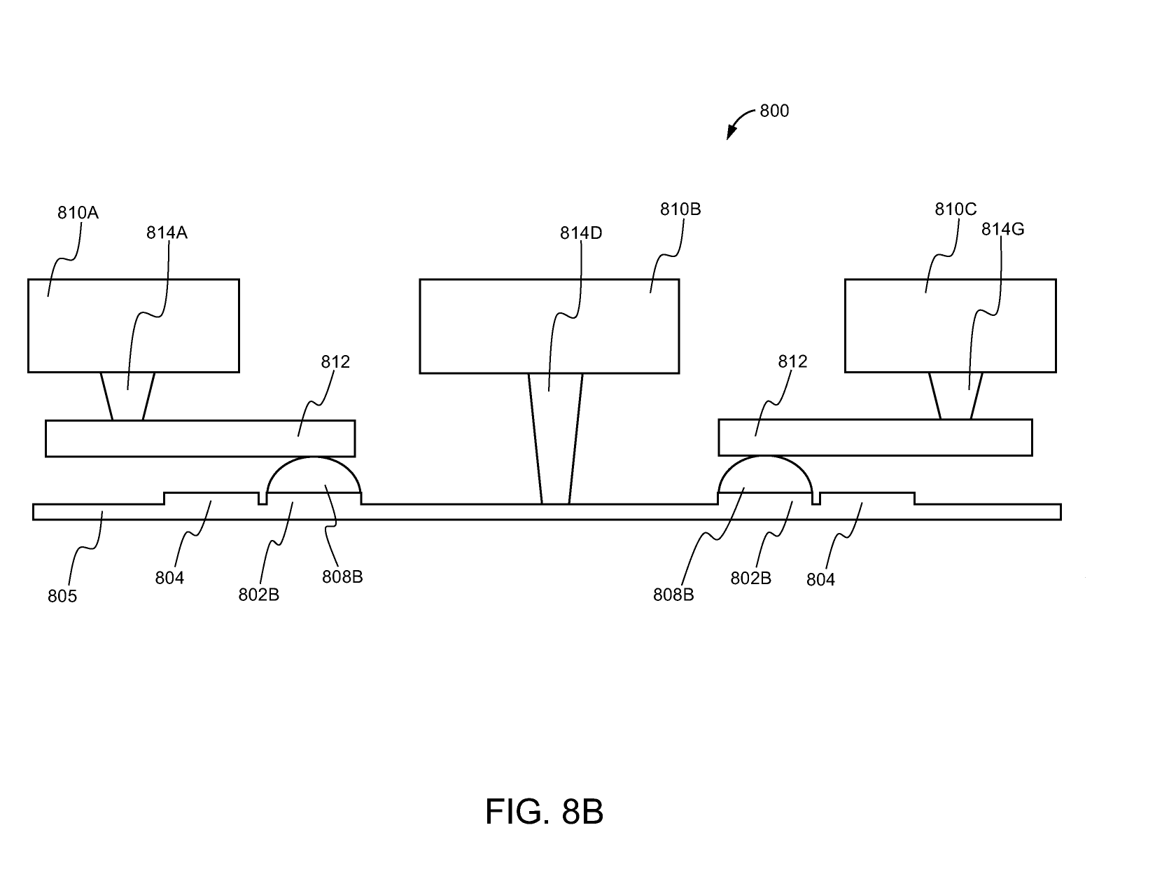

An example device 800 configured as a photodiode is shown in FIG. 8A and a cutaway view of the device 800 along the plane 801 is shown in FIG. 8B. The device 800 comprises a first CWS 802A, a second CWS 802B, and a coupling waveguiding structure 804 configured to guide optical waves along a path outside the first CWS 802A and the second CWS 802B. The first CWS 802A, a second CWS 802B, and a coupling waveguiding structure 804 are formed from a substrate 805. The coupling waveguiding structure 804 comprises a plurality of optical coupling portions 806A-806D, i.e., an optical coupling portion 806A, an optical coupling portion 806B, an optical coupling portion 806C, and an optical coupling portion 806D. Each optical coupling portion of the plurality of optical coupling portions 806A-806D is configured to couple portions of optical waves into the first CWS 802A or the second CWS 802B. Each of the first CWS 802A and the second CWS 802B is in optical communication with a first absorbing structure 808A and a second absorbing structure 808B. An optical wave 809 is provided to the coupling waveguiding structure 804.

The device 800 further comprises circuitry configured to detect optical waves at least partially absorbed by each of the first absorbing structure 808A and the second absorbing structure 808B. In this example, the circuitry comprises a plurality of metal contacts 810A-810C, i.e., a metal contact 810A, a metal contact 810B, and a metal contact 810C, arranged in a first layer that is substantially coplanar with a first plane. In some examples, the metal contact 810A and the metal contact 810C can be configured as cathodes while the metal contact 810B can be configured as an anode. The circuitry further comprises a conducting material 812 within a second layer that is substantially coplanar with a second plane that is parallel to the first plane. In some implementations, the first CWS 802A and the second CWS 802B can be formed from doped portions of the substrate 805, i.e., portions comprising dopants mixed within. The circuitry further comprises conductive structures connecting the conducting material 812, the doped portions of the substrate 805, and the plurality of metal contacts 810A-810C. In this example, the conductive structures are a plurality of vias 814A-814H, i.e., a via 814A, a via 814B, a via 814C, a via 814D, a via 814E, a via 814F, a via 814G, and a via 814H. The plurality of vias 814A-814H is configured to connect each metal contact of the plurality of metal contacts 810A-810C to the conducting material 812 in the second layer or to doped portions of the substrate 805. For instance, the via 814C, the via 814D, the via 814E, and the via 814F are configured to connect the metal contact 810B to doped portions of the substrate 805. Each via of the plurality of vias 814-814H extends along a respective axis that is perpendicular to the first plane. Each of the first CWS 802A and the second CWS 802B forms a curve that encircles at least a via of the plurality of vias 814A-814H. By way of example, FIG. 8A depicts the first CWS 802A forming a curve that encircles the via 814E and the via 814F, and the second CWS 802B forming a curve that encircles the via 814C and the via 814D.

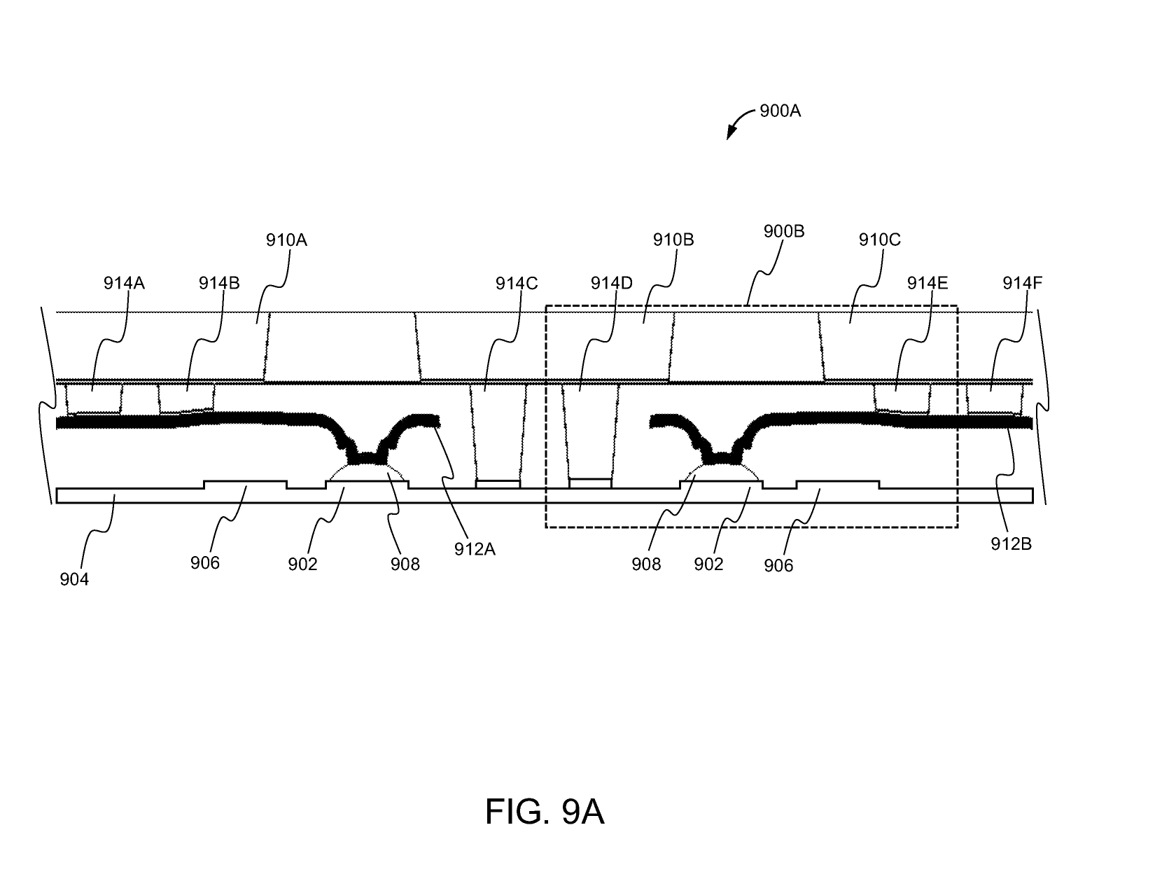

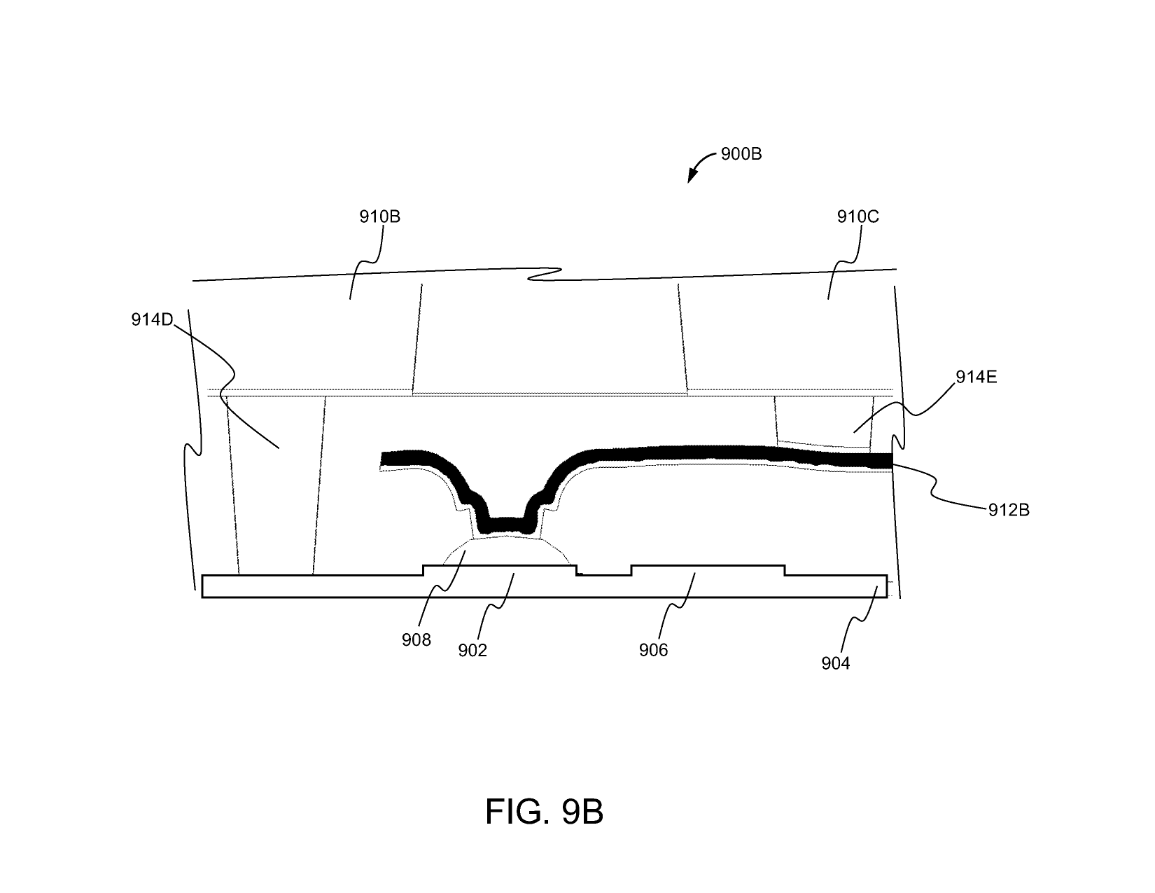

An example device 900A is shown in FIG. 9A and a close-up view of the portion 900B of the device 900A is shown in FIG. 9B. The device 900A comprises a CWS 902 formed from a substrate 904. In some implementations, a portion of the substrate 904 from which the CWS 902 is formed can comprise dopants mixed within. In other words, the CWS 902 can be formed from a doped portion of the substrate 904. A coupling waveguiding structure 906 is formed in proximity to the CWS 902. An absorbing structure 908 is formed on top of the CWS 902. Circuitry is configured to be in electrical communication with portions of the device 900A. In this example, the circuitry comprises a plurality of metal contacts 910A-910C, i.e., a metal contact 910A, a metal contact 910B, and a metal contact 910C. A conductive structure 912A and a conductive structure 912B are in electrical communication with the absorbing structure 908. The plurality of metal contacts 910A-910C is in electrical communication with the conductive structure 912A, the conductive structure 912B, and the doped portion of the substrate 904 by a plurality of vias 914A-914F, i.e., a via 914A, a via 914B, a via 914C, a via 914D, a via 914E, and a via 914F. In other words, the conductive structure 912A, the conductive structure 912B, and the doped portion of the substrate 904 form a pin junction that is in electrical communication with the plurality of metal contacts 910A-910C.

In some examples, a fabrication process for the device 900A can comprise one or more of the following steps: Silicon on insulator (SOI) wafers can be used and the silicon can be patterned to generate the waveguides, i.e., the CWS 902 and the coupling waveguiding structure 906. In some examples, rib waveguides can be generated. The silicon slab, i.e., the substrate 904, can be implanted, and the dopants activated by thermal anneal. Silicon can be encapsulated with silicon dioxide and a window can be etched back to expose only a ring or racetrack section, i.e., the CWS 902, of the silicon on the inner waveguides. An absorbing structure 908 can then be deposited on the CWS 902. For instance, an absorbing structure 908 comprising germanium can be deposited only on the exposed silicon of the CWS 902 by selective epitaxial growth. The absorbing structure 908, i.e., germanium, can be encapsulated and a local window can be etched to access the top section only. The conductive structure 912A and the conductive structure 912B can then be formed. In some implementations, the conductive structure 912A and the conductive structure 912B can be formed from a conducting material such as polysilicon that can be deposited and patterned. In-situ doped polysilicon or intrinsic silicon can be used, followed by implantation. The upper surface of polysilicon can be silicided to improve electrical conductivity. Metal vias and lines can be processed to contact the junction electrodes.

In some examples, two parallel waveguides can be used for directional coupling. As shown in FIG. 9B, the CWS 902 can have an absorbing structure 908 formed on the waveguide, i.e., a grown germanium crystal atop the waveguide, which can be contacted using the doped silicon slab, i.e., a doped portion of the substrate 904 from which the CWS 902 is formed, and doped polysilicon, i.e., the conductive structure 912A and the conductive structure 912B.

Without using the methods disclosed herein, a photodiode device can be associated with one or more of the following disadvantages. In linear photodiodes, the device responsivity can be low for short devices. Some short devices can be used to achieve high-speed because of capacitance constraints. Moreover, Ge absorption can be wavelength dependent and the wavelength dependence can be visible in linear devices. Some photodiodes can be configured as discs. However, some disc devices are not efficient because part of the optical light can scatter and not follow the gallery mode of the disc. Moreover, the transition to a Ge disc can be inefficient. Light can be injected and transit through a highly doped region in silicon. A substantial amount of light can be absorbed in that region and generate slow carriers, which can reduce the device speed. Further, fabrication of devices can be challenging because electrical contacts are done both on Si and Ge. Besides process constraints, contacts on Ge can be associated with absorption, responsivity loss, and/or higher dark current.

In contrast, a ring photodiode structure can be more effective, both for mode transition and confinement.

In some examples, a directional coupler configuration can inject light in an intrinsic Si slab. The light can then be coupled in a Ge ring. The PIN diode can be placed between the upper part of Ge and part of the underlying Si. The central part of the ring is in Si and can be used to position one electrode. Highly doped poly-Si can be placed on the Ge and redistributed to position the second electrode.

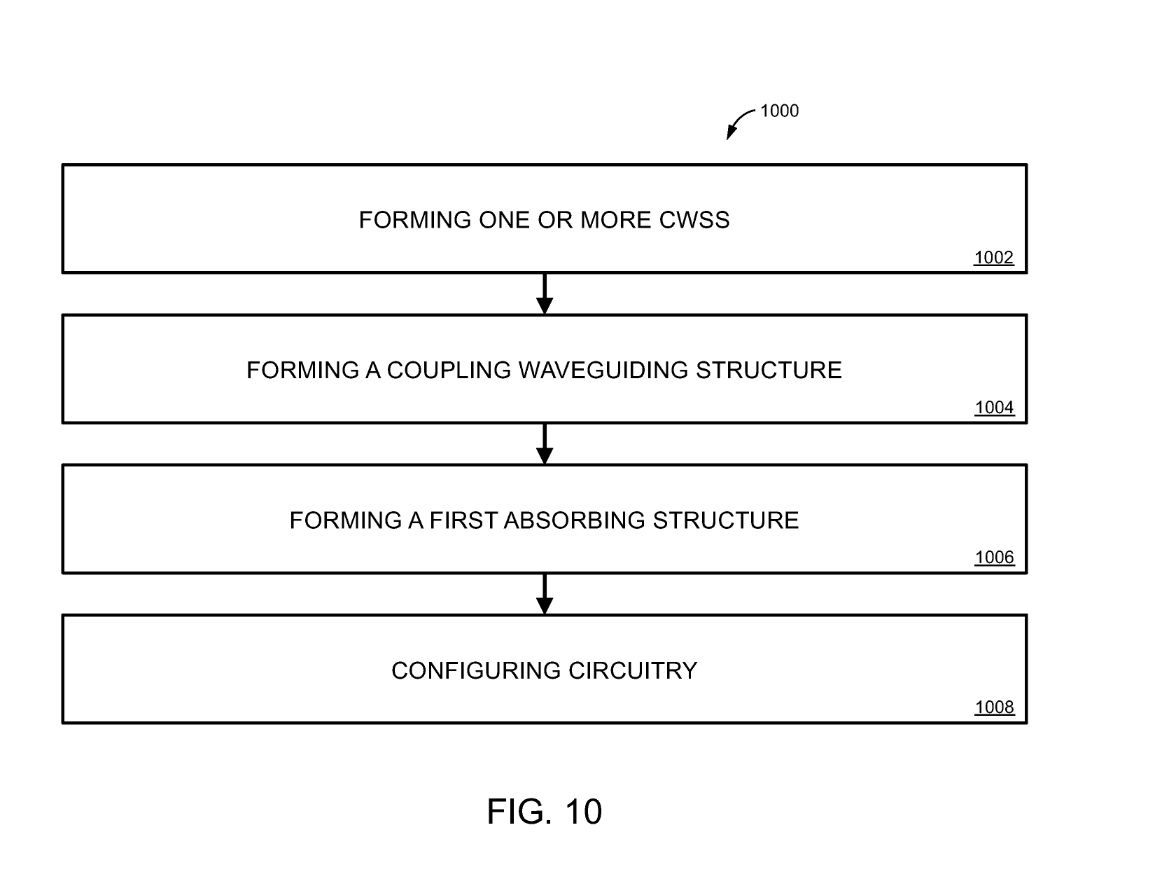

FIG. 10 depicts a flowchart of an example method 1000 associated with configuring devices. The method 1000 comprises forming 1002 one or more closed-loop waveguiding structures (CWSs). In some implementations, the one or more CWSs can be formed from a core material and can be configured to guide optical waves along a closed-loop path. The one or more CWSs can include a first CWS. The method 1000 further comprises forming 1004 a coupling waveguiding structure. In some examples, the coupling waveguiding structure can be formed from the core material and can comprise a first optical coupling portion configured to optically couple at least a portion of an optical wave propagating through the coupling waveguiding structure into the first CWS, and a second optical coupling portion configured to optically couple at least a portion of an optical wave propagating through the coupling waveguiding structure into the first CWS. The method 1000 further comprises forming 1006 a first absorbing structure. In some implementations, the first absorbing structure can be in optical communication with the first CWS. The method 1000 further comprises configuring 1008 circuitry. In some implementations, the circuitry can be configured to detect optical waves at least partially absorbed by the first absorbing structure.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for detecting optical waves, the apparatus comprising:
one or more closed-loop waveguiding structures (CWSs) formed from a core material, each CWS configured to guide optical waves along a closed-loop path, including a first CWS;
a coupling waveguiding structure formed from the core material, the coupling waveguiding structure comprising
a first optical coupling portion configured to optically couple at least a portion of an optical wave propagating through the coupling waveguiding structure into the first CWS, and
a second optical coupling portion configured to optically couple at least a portion of an optical wave propagating through the coupling waveguiding structure into the first CWS;
a first absorbing structure in optical communication with the first CWS; and
circuitry configured to detect optical waves at least partially absorbed by the first absorbing structure;
wherein the coupling waveguiding structure is configured to guide optical waves along a path outside the one or more CWSs.

2. The apparatus of claim 1, wherein the first optical coupling portion and the second optical coupling portion are each configured to couple a respective percentage of electromagnetic power relative to a total electromagnetic power associated with an optical wave propagating through the coupling waveguiding structure into the first CWS.

3. The apparatus of claim 2, wherein the first optical coupling portion is configured to couple a respective percentage of electromagnetic power that is greater than 40% relative to a total electromagnetic power of an optical wave propagating through the coupling waveguiding structure into the first CWS.

4. The apparatus of claim 2, wherein the second optical coupling portion is configured to couple a respective percentage of electromagnetic power that is greater than 90% relative to a total electromagnetic power of an optical wave propagating through the coupling waveguiding structure into the first CWS.

5. The apparatus of claim 2, wherein the first optical coupling portion and the second optical coupling portion are each configured to couple a respective percentage of electromagnetic power relative to a total electromagnetic power associated with an optical wave propagating through the coupling waveguiding structure into the first CWS based at least in part on one or more optical wavelengths associated with the optical wave.

6. The apparatus of claim 1, wherein
the one or more CWSs further comprises a second CWS,
the coupling waveguiding structure further comprises
a third optical coupling portion configured to optically couple at least a portion of an optical wave propagating through the coupling waveguiding structure into the second CWS, and
a fourth optical coupling portion configured to optically couple at least a portion of an optical wave propagating through the coupling waveguiding structure into the second CWS.

7. The apparatus of claim 6, wherein
the first CWS and the second CWS are distributed along a first axis,
the first optical coupling portion and the second optical coupling portion are distributed along a second axis that is perpendicular to the first axis, and
the third optical coupling portion and the fourth optical coupling portion are distributed along a third axis that is substantially parallel to the second axis.

8. The apparatus of claim 6, further comprising a second absorbing structure in optical communication with the second CWS.

9. The apparatus of claim 8, wherein the circuitry is further configured to detect optical waves at least partially absorbed by the second absorbing structure.

10. The apparatus of claim 9, wherein the circuitry comprises
a plurality of metal contacts arranged in a first layer that is substantially coplanar with a first plane,
a conducting material within a second layer that is substantially coplanar with a second plane that is parallel to the first plane,
one or more doped portions of the core material, where the one or more CWSs are formed from the one or more doped portions of the core material, and
a plurality of vias connecting each metal contact of the plurality of metal contacts to the conducting material in the second layer or the one or more doped portions of the core material, where each via of the plurality of vias extends along a respective axis that is perpendicular to the first plane.

11. The apparatus of claim 10, wherein the first CWS forms a curve that encircles at least a first via of the plurality of vias and the second CWS forms a curve that encircles at least a second via of the plurality of vias.

12. The apparatus of claim 6, wherein the first optical coupling portion and the second optical coupling portion are each configured to couple a respective percentage of electromagnetic power relative to a total electromagnetic power associated with an optical wave propagating through the coupling waveguiding structure into the first CWS, and the third optical coupling portion and the fourth optical coupling portion are each configured to couple a respective percentage of electromagnetic power relative to a total electromagnetic power associated with an optical wave propagating through the coupling waveguiding structure into the second CWS.

13. The apparatus of claim 6, wherein
a first portion of the coupling waveguiding structure between the first optical coupling portion and the third optical coupling portion is configured to provide a predetermined optical delay to an optical wave propagating through the first portion of the coupling waveguiding structure,
a second portion of the coupling waveguiding structure between the third optical coupling portion and the fourth optical coupling portion is configured to provide a predetermined optical delay to an optical wave propagating through the second portion of the coupling waveguiding structure, and
a third portion of the coupling waveguiding structure between the fourth optical coupling portion and the second optical coupling portion is configured to provide a predetermined optical delay to an optical wave propagating through the third portion of the coupling waveguiding structure.

14. The apparatus of claim 1, wherein at least a portion of the coupling waveguiding structure between the first optical coupling portion and the second optical coupling portion is configured to provide a predetermined optical delay to an optical wave propagating through the portion of the coupling waveguiding structure.

15. The apparatus of claim 1, wherein the core material comprises silicon.

16. The apparatus of claim 1, wherein the first absorbing structure comprises a material associated with a higher refractive index than a refractive index associated with the core material.

17. The apparatus of claim 1, wherein the optical communication between the first absorbing structure and the first CWS comprises an evanescent coupling between an optical mode associated with the first CWS and an optical mode associated with the first absorbing structure.

18. The apparatus of claim 1, wherein the first absorbing structure comprises an absorbing material forming a layer over the first CWS.

19. The apparatus of claim 18, wherein the absorbing material comprises germanium.

20. A method comprising:
forming one or more closed-loop waveguiding structures (CWSs) from a core material, each CWS configured to guide optical waves along a closed-loop path, including a first CWS;
forming a coupling waveguiding structure from the core material, the coupling waveguiding structure comprising
a first optical coupling portion configured to optically couple at least a portion of an optical wave propagating through the coupling waveguiding structure into the first CWS, and
a second optical coupling portion configured to optically couple at least a portion of an optical wave propagating through the coupling waveguiding structure into the first CWS;
forming a first absorbing structure in optical communication with the first CWS; and
configuring circuitry to detect optical waves at least partially absorbed by the first absorbing structure;
wherein the coupling waveguiding structure is configured to guide optical waves along a path outside the one or more CWSs.
